(19) United States
(12) Patent Application Publication
(10) Pub. No.: US 2017/0110003 A1
(43) Pub. Date: Apr. 20, 2017

(54) FIRE ALARM LOOP CALIBRATION AND FAULT LOCATION

(71) Applicant: Honeywell International Inc., Morristown, NJ (US)

(72) Inventor: Michael Barson, Nuneaton (GB)

(21) Appl. No.: 14/882,627

(22) Filed: Oct. 14, 2015

(51) Int. Cl. G08B 29/12

(52) U.S. Cl. CPC G08B 29/123

(57) ABSTRACT

An apparatus is provided that includes a two-wire loop having first and second conductors that connect a monitoring system with a plurality of addressable sensors and alarm devices of the monitoring system, the two-wire loop having first and second ends connected to the monitoring system, a memory that contains first respective resistance values of the first and second conductors and second respective resistance values between the first and second ends and each of the plurality of addressable sensors and alarm devices, and a processor that detects a fault in the two-wire loop by measuring third resistance values from opposing ones of the first and second ends of the two-wire loop during a scan of the plurality of addressable sensors and alarm devices and compares the third resistance values with corresponding ones of the first and second respective resistance values in the memory.

### FIELD

This application relates to monitoring systems and more particular to loop parameter monitoring and calibration in analogue addressable fire systems.

### BACKGROUND

Monitoring systems are known to protect life and property within protected areas. Such systems are typically based upon the use of one more sensors that detect threats within the areas.

Threats to people and assets may originate from any of number of different sources. For example, a fire may kill or injure occupants who have become trapped by a fire in a building. Similarly, carbon monoxide from a fire may kill people in their sleep.

In order to address these threats, a number of fire sensors and alarm devices may be distributed throughout a home or business. The fire sensors may be based upon any of a number of different detection technologies (e.g., smoke, heat, toxic gases, etc.). The alarm devices may also be based upon different technologies (e.g., sounders, strobes, voice alarm speakers, etc.) and may even be integrated into the fire sensors

In most cases, fire detectors are connected to a local control panel. Large systems may include a number of networked control panels. In the event of a threat detected via one of the sensors, the control panel may activate the alarm devices. The control panel may also send a signal that alerts a central monitoring station.

The fire sensors may be connected to the local control panel via a two-wire (2-wire) loop. The 2-wire loop may serve the dual functions of providing power to the sensors as well as providing a communication connection.

While fire alarm systems work well, they can sometimes fail to properly notify occupants of threats from fires originating within a secured area. In many cases, the failure may be attributed to failure of the communication connection provided through the 2-wire loop. This may cause some fire detectors and/or alarm devices to fail to operate properly or to otherwise report a fire. Accordingly, a need exists for better methods and apparatus for detecting failure of 2-wire loops.

### BRIEF DESCRIPTION OF THE DRAWINGS

FIG. 1 is a block diagram of a monitoring system shown generally in accordance with an illustrated embodiment;

FIG. 2 is a simplified loop circuit diagram of an analogue addressable fire alarm system of the system of FIG. 1 when conducting a loop resistance and calibration test; and

FIG. 3 is a simplified loop circuit diagram of an analogue addressable fire alarm system of the system of FIG. 1 when conducting a resistance, calibration and location test.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Many analogue addressable fire alarm systems use combined power transmission and digital communications on a screened 2-wire loop between a control panel and a number of outstations or field devices. Generally, the outstations will mainly consist of fire detectors or sensors and alarm devices, each combined with a communication interface. The status of each outstation is continuously monitored by the panel, so that fires or faults can be determined. If a fire is detected, the panel will go into an alarm state and activate a number of alarm alerting devices, which, in turn, causes a large increase in loop current to occur.

The digital communication between the panel and the outstations can normally only detect quite severe loop faults such as an open circuit in the case where communications replies from outstations would only be seen on the particular end of the loop wiring still connected to the control panel. In this case, the location of the fault can be easily deduced. However one (or even more) partial open circuits, for example, may still allow reliable digital communication. In this case, faults could remain undetected and when a fire is detected and the panel tries to activate the alarm devices, a complete collapse of the loop could occur.

This wiring integrity problem is known to at least some experts in the fire alarm industry and product standards are currently being developed to address this issue, with tests that require wiring faults to be detected at the earliest stage possible, in order to improve the reliability of fire alarm systems.

On the other hand, with the passage of time, manufactures have required such loops to power even more devices over longer distances using alarm devices which often require significantly more power. This implies that the loop wiring has to be both monitored more accurately and with a finer resolution, as it may be less tolerant to quite small increases in some loop parameters like loop resistance i.e. a partial loop resistance fault. Additionally, on a more practical level, if such a fault (or faults) could detected at an earlier stage and the precise location(s) on a loop (which could be 2 Km long and contain 200 outstations) detected, it would be highly beneficial for a commissioning or maintenance Engineer.

There have been a number of prior attempts to address these issues. For example, European patent EP2706518 A1 discloses an addressable loop system with class A wiring, which measures loop parameters including loop resistance. However, this patent fails to disclose any method of detecting very small changes in the loop parameters, especially in the loop resistance measurement. Additionally, this patent does not disclose any method of accurately locating the actual position of one or more partial open circuits in the loop wiring.

Similarly, U.S. Pat. No. US2011/0150188 A1 discloses an addressable loop system that periodically disconnects the loop from a control panel and then replaces the loop with a simulated outstation or subscriber so that the parameters of the communication circuit within the panel or control centre can be tested i.e. it is a self-test of the control centre. When the loop is re-connected, the control panel uses standard digital communications to find basic faults. However, the digital communications of the control panel need to be very robust and are inherently insensitive to normal cable parameter variations, so this type of loop monitoring is not capable of detecting cable problems until the communications starts to fail, which usually causes a total unrecoverable collapse and the cause of the fault difficult to find.

Turning now to the system shown in the figures, this application describes a number of embodiments set in the context of monitoring systems and, more particularly, to the use of loop monitoring and calibration techniques in a loop monitoring system that operates from within an analogue addressable fire alarm system and that operates in particular for the detection and location of series resistance faults.

The loop monitoring system is applicable to any analogue addressable fire alarm systems, such as loop-based systems within building management system(s). Typical exemplary systems which may be applicable to the present application include fire alarm panels, intruder detection systems, voice alarm systems, access control systems, nurse call systems, disabled toilet alarms and disabled refuge systems.

In one illustrated embodiment, the loop monitoring is applied to a 2-wire loop that connects the control panel of a monitoring system with the sensors of the monitoring system. This system described below operates to improve the reliability of a monitoring system by detecting faults in the 2-wire loop. The loop monitoring system relies upon the measurement of series loop resistance, for example, in an analogue addressable fire alarm system using a 2-wire loop that also provides combined power transmission and data communications. This however, does not exclude other loop parameters being used.

Under illustrated embodiments, two different techniques may be used to measure small changes in the loop resistance; the first obtains an accurate overall resistance on each conductor leg and the total loop resistance. The resistance measurements are then used as calibrated values saved in memory, to monitor for small changes and hence to detect faults. The second technique measures the resistance between outstations. As this is typically a faction of an Ohm on a normal loop, a small change in any resistance value between points compared to the overall loop resistance value, can easily be detected as a fault and used to locate the fault position. It should be noted that because wiring faults nearly always occur at wiring termination points, it is this position that needs to be located and reported. In other words the reported location will be at an outstation address or loop connection position.

The first measurement technique measures the loop resistance in a communication low. For example, the control panel may transmit message including a sequence of “1”s and “0”s where the “0”s represent the communication lows.

A virtual outstation with an unused loop address (i.e., a non-existent sensor) is used by the panel during the measurements. This implies that all the actual outstations will ignore the measurement and normal loop communications can, otherwise, be maintained. Since the measurements occur only during a logic low, only the measurement current will be flowing from a current source within the control panel during the measurement, so that an accurate resistance reading can be obtained without any errors due to quiescent or alarm currents.

Resistance measurements are then calculated for the total loop and each leg of the loop. The values are then analyzed to ensure that they are suitable, in other words within the limits which would be expected, are not marginal and are stable. The resistance values are then stored in memory and used as calibrated values, to monitor for relativity small percentage changes and hence are used to indicate a fault condition. The calibration values are normally taken when a back-up of the loop configuration is made to non-volatile memory (NVM) after the commission stage of the system.

The second technique differs in that it uses a sequential scan of the actual outstations connected to the loop. If we assume for simplicity that each device along the loop is sequentially addressed and will reply in location order, then its data communications (responses) can be monitored for its reply voltage level i.e. the voltage level during a logic low reply, as measured from a particular end of the loop wiring. The panel will then take a respective analogue to digital (ADC) measurement of the reply voltages at each end of the loop, from each outstation.

If we also assume that accurate current sources are used in the panel during the communication reply from an outstation, and the impedances of all outstations are equal when transmitting this logic low level, then the resistance between each outstation can be calculated from the difference between two ADC values obtained in sequential order, when measured from a particular end of the loop.

All the resistance values between each outstation and the resistance values between the first and last outstation connected to the panel can then be calculated and recorded. The values are then analyzed and if suitable, can be used as calibrated values, so that changes in one or more of the resistance values can be used to detect and locate the position of resistance faults. The calibration values are normally taken when a back-up of the loop configuration is made to non volatile memory (NVM) after the commission stage or initial startup of the system.

Any of the previously described resistance measurement techniques could be used independently, however if both methods are employed together, then an overall benefit occurs. Absolute accuracy in the total loop resistance and in the resistance of each conductor (each leg) can be made and compared to the maximum values allowed for a certain loop configuration. The actual resistance values can then be monitored for small changes, indicating a fault at an early stage before the loop could be compromised. Additionally the location of one or more resistance faults could easily be detected and located on the loop.

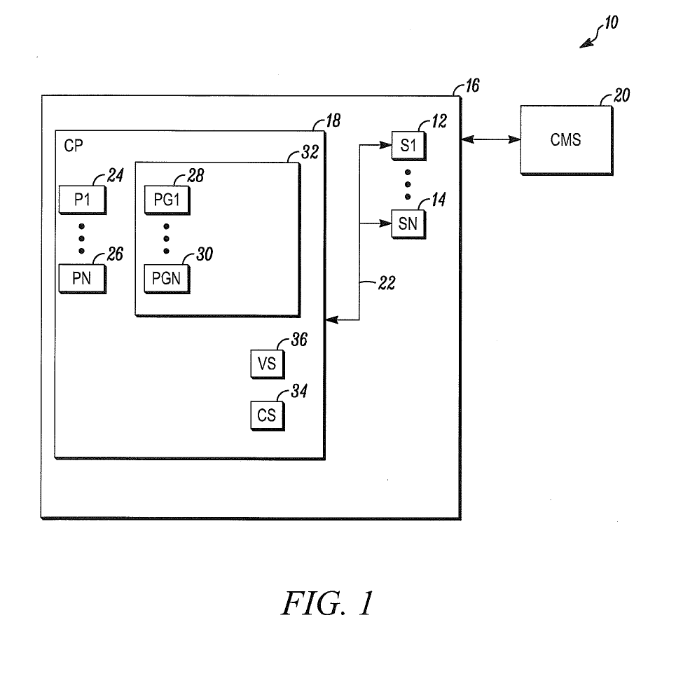

FIG. 1 is a block diagram of a monitoring and/or security system 10 that incorporates the loop monitoring system discussed above. In a broader context, the monitoring system may be embodied as a fire detection system, by itself, or may provide other additional features, such as intrusion detection.

As shown, the monitoring system includes a number of sensors and/or alerting devices (outstations) 12, 14 that detect threats within a secured area 16. The sensors may include one or more of any of a number of different types of sensors (e.g., smoke detectors, heat detectors, carbon monoxide detectors, etc.).

If the system also performs intrusion detection, then the sensors may include limit switches placed on the doors and/or windows providing entrance into and egress from the secured area. The system may also include motion detection capabilities provided by passive infrared (PIR) directors or closed circuit television (CCTV) cameras with one or more associated processors that compare a sequence of images for differences indicating motion.

The sensors may be monitored by a control panel 18. Upon detecting activation of one of the sensors, the control panel may send an alarm message to a central monitoring station 20. The central monitoring station may respond by summoning help (e.g., fire department, police, etc.).

The sensors are connected to the control panel via at least one 2-wire loop 22. The 2-wire loop supplies power to each of the sensors as well as providing a communication connection.

Included within each of the sensors and control panel is control circuitry that accomplishes the functionality described below. The circuitry may include one or more processor apparatus (processors) 24, 26, each operating under control of one or more computer programs 28, 30 loaded from a non-transitory computer readable medium (memory) 32 within the control panel and within a current sensor 34 and voltage sensor 36. As used herein, reference to a step performed by a computer program is also reference to the processor that executed that step.

For example, a loop processor may monitor each of the sensors on a 2-wire loop. If a fire is detected at one or more of the sensors, the loop processor may activate the alarm devices in one or more of the secured or protected areas, depending on the cause and effect programmed into the fire alarm system. A main processor may also compose and send an alarm message to the central monitoring station. The alarm message may include an identifier of the monitoring system (e.g., an account number, address, etc.), an identifier of the type of alarm (e.g., fire, intrusion, etc.), an identifier of the activated sensor, a location of the sensor within the secured area and a time of activation.

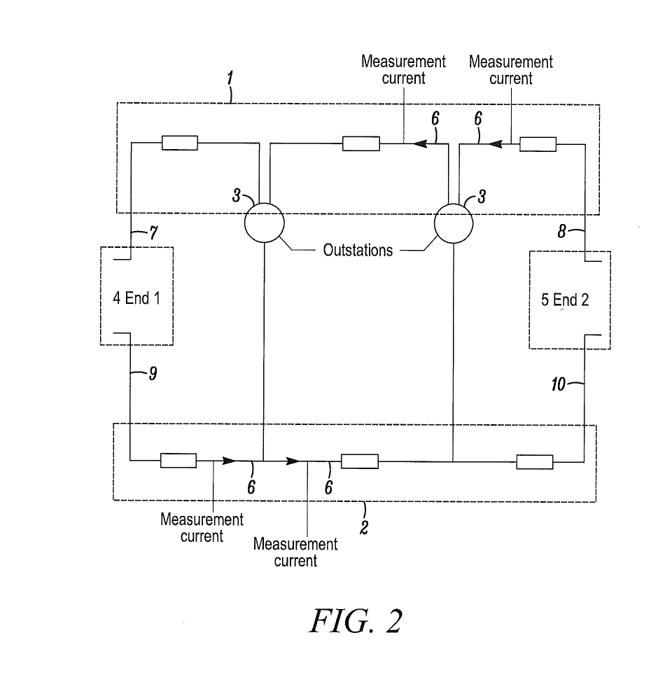

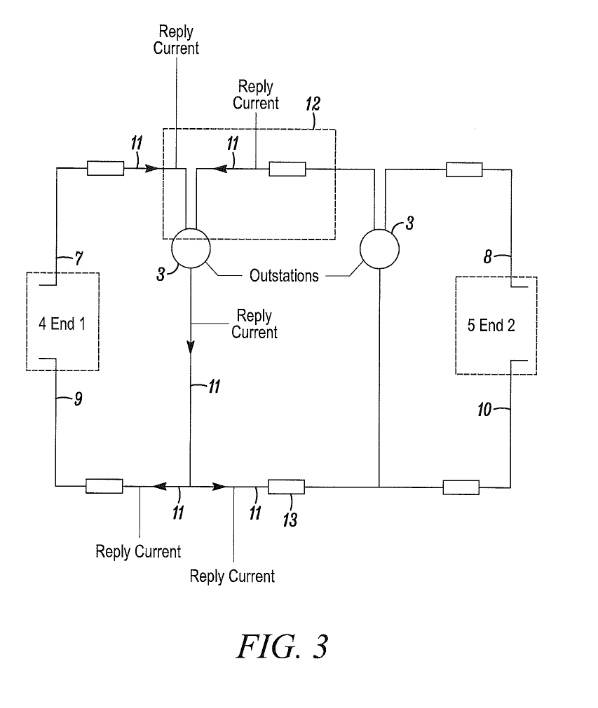

The loop monitoring system shown in the system of FIG. 1 may be described in more detail using FIGS. 2 and 3. FIG. 2 is a simplified circuit diagram of an analogue addressable fire alarm system used by the system of FIG. 1 when conducting a loop resistance and calibration test and FIG. 3 is a simplified circuit diagram of an analogue addressable fire alarm system of the system of FIG. 1 when conducting a resistance, calibration and location test.

FIG. 2 shows a simplified diagram of the fire alarm loop 22 of FIG. 1. The loop includes a first conductor (identified by reference number 1 in FIG. 2) and a second conductor (identified by reference number 2 in FIG. 2). One or more processors of the loop monitoring system may access the first and second conductors when conducting a loop resistance and calibration test. The resistance measurements are taken during a transmitted communication low of the loop protocol using a current sensor 34 and a voltage sensor 36. A virtual outstation (sensor) with an unused loop address is used by the panel during the measurements, so that all the actual outstations will ignore the measurement and normal loop communications can be maintained. In this communications low, an accurate measurement current 6 is injected into End2 of the loop 5 and travels through the total resistance of the positive leg 1 into End1 of the loop 4. It should be noted that the total resistance of the positive leg 1 also includes the isolator resistance of all outstations 3.

The same measuring current 6 also flows in the total resistance of the negative leg 2 returning back to End2 of the loop 5. Measuring the voltage difference, via a voltage sensor 36, between End1 positive 7 and End2 positive 8 then dividing by the measurement current 6, gives the total resistance of the positive leg. Similarly measuring the voltage difference between End1 negative 9 and End2 negative 10, then dividing by the measurement current 6, gives the total resistance of the negative leg 2. The total loop resistance is therefore the sum of the total resistance of the positive leg 1 and the negative leg 2.

The values are then analyzed to ensure that they are suitable, in other words within the limits which would be expected, are not marginal and are stable. The resistance values are then stored in memory and used as calibrated values. These values are then monitored in the live system for relativity small percentage changes in resistance and hence the panel can easily detect a fault condition. The calibration values are normally taken when a back-up of the loop configuration is made to non volatile memory (NVM) after the commission stage of the system. It should be clear that the resistance fault limits are not fixed, as the limits are dependent on the calibrated resistance values taken. Thus a short loop will have a lower fault limit than a longer loop with more cable and outstation resistances.

It should also be noted that while the resistance of a copper cable increases with temperature, both legs are equally affected and use the same measurement current, and as a consequence, this variation can be compensated for by comparing the relative change in resistance of both legs. In other words, the system can be made more sensitive to a differential change in the resistance of the legs as this is indicative of a real wiring fault. It should be clear that relativity small changes to the resistance of any leg compared to the overall loop resistance can be reliably detected by the system, to maintain the wiring integrity.

For example, a fault could be generated if one of the following equations is true:

R_loop>R_loop_cal×1.2 1)

R1>R1_cal×1.2 2)

R2>R2_cal×1.2 3)

|ΔR1−ΔR2|>5 4)

### Where:

R1 is the total resistance of the positive leg.
R2 is the total resistance of the negative leg.
R_loop is the total loop resistance or R1+R2.
R1_cal is the calibrated value of R1.
R2_cal is the calibrated value of R2.
R_loop_cal is the calibrated value of the loop resistance.
ΔR1=100×(R1−R1_cal)/(R1_cal).
ΔR2=100×(R2−R2_cal)/(R2_cal).

In general, FIG. 2 shows a simplified diagram of a fire alarm loop when conducting a resistance, calibration and location test. A processor of the control panel connected to End1 of the loop 4 and End2 of the loop 5 communicates periodically with the outstations 3 using a sequential scan. If we assume for simplicity that each device is addressed and will reply in location order, with its data communications monitored for its reply voltage level i.e. the voltage level during a logic low reply, as measured from a particular end of the loop wiring, then a processor of the panel will then take an accurate analogue to digital (ADC) measurement of the reply voltages at each end of the loop, from each outstation.

Two accurate current sources in the control panel provide a reading of the reply current 11 during the communication reply low level from the scanned outstations 3. As the outstation 3 have equal impedances, the voltage levels measured on End1 of the loop 4 and End2 of the loop 5 enable the resistance between each outstation to be calculated from the difference between two ADC values obtained in sequential order from one end of the loop to the other, when measured from a particular end of the loop. This technique will even work if the loop is split, as both ends of the loop are fed by separate current sources and the resistance calculations can easily take this change of monitoring current into account.

The resistance value between any two outstations 3 in location order includes the cable resistance between the particular two outstations in the positive leg, an outstation isolator resistance 12 and the cable resistance between the particular two outstations in the negative leg 13.

All the resistance values between each outstation and the resistance values between the first and last outstation connected to the panel can then be calculated and recorded. The values are then analyzed and if suitable, can be used as calibrated values, so that small changes in one or more of the resistance values can be used to detect and locate the position of resistance faults. The calibration values are normally taken when a back-up of the loop configuration is made to non-volatile memory (NVM) after the commission stage of the system. The actual resistance values (taken during normal operation) can then be monitored for small changes, indicating a fault at an early stage before the loop could be compromised.

For example if a user were to assume:

ΔV_End1≈I_reply (ΔR)

and

ΔV_End2≈I_reply (ΔR)

Then, the value of the resistance between each Outstation can then be calculated, calibrated and fault limits set:

ΔR>(ΔR_cal×1.2)+1

### Where:

ΔV_End1 is the variation in voltage measured between Outstations, as seen from End1.
ΔV_End2 is the variation in voltage measured between Outstations, as seen from End2.
I_reply is the reply current during a low from an Outstation.
ΔR is the resistance between particular Outstations.
ΔR_cal is the calibrated resistance between particular Outstations.

Any of the resistance measurement techniques shown in FIG. 2 or in FIG. 3 could be used independently to detect a fault, however if both methods are employed together, then an overall benefit occurs. Absolute accuracy in the total loop resistance and in the resistance of each conductor (each leg) can be established by measurement and compared to the maximum values allowed for a certain loop configuration. The location of one or more resistance faults could, thus, easily be detected.

In FIG. 3, for example, with less than 1 Ohm between outstations, a fault could be detected if more than a 200% change in resistance were to occur, however this could be equivalent to an increase of just over 1% in the total loop resistance. It is therefore possible to reliably determine very small resistance faults, with the actual position on the loop determined using the outstations addresses.

While specific illustrated implementations have been described above in relation to fire alarm systems, the present invention is equally relevant and applicable to other loop-based systems typically within a building management system, and also systems which include fire alarm panels, intruder detection systems, voice alarm systems, access control systems, nurse call systems, disabled toilet alarms and disabled refuge systems, and such systems will likewise benefit from the inherent advantages resulting from the present invention. Implementation of the present invention to these other forms of system would be evident to the skilled man.

The loop monitoring system described above is applicable to analogue addressable fire alarm systems and to loop-based systems with a building management system. Typical exemplary systems which may be applicable to the present invention include fire alarm panels, intruder systems, voice alarm systems, access control systems, nurse call systems, disabled toilet alarms and disabled refuge systems. The method and system of the present invention provides accurate fault detection and location in analogue addressable fire systems and other systems in circumstances that have not previously been possible.

In general, the system includes a 2-wire loop having first and second conductors that connect a monitoring system with a plurality of sensors of the monitoring system, the 2-wire loop having first and second ends connected to the monitoring system, a memory that contains respective resistance values of the first and second conductors and respective resistance values between the first and second ends and each of the plurality of sensors and a processor that detects a fault in the 2-wire loop by measuring resistance values from opposing ends of the 2-wire loop during a sensor addressing cycle and compares the measured resistance values with the corresponding resistance values in memory.

Alternatively, the system may include a monitoring system that protects a secured geographic area, a plurality of sensors of the monitoring system that detect threats within the secured geographic area, a 2-wire loop having first and second conductors that connect the plurality of sensors and monitoring system, the 2-wire loop having a first end connected to the monitoring system and a second, opposing end also connected to the monitoring system, a first set of memory locations that contain a respective resistance value of each of the first and second conductors, a second set of memory locations that contain a respective resistance value between the first end and each of the plurality of sensors and between the second end and each of the plurality of sensors and a processor that detects a fault in the 2-wire loop by measuring resistance values from opposing ends of the 2-wire loop during a scan of addressed devices where a message is sequentially sent to each device and compares the measured resistance values with corresponding values of the first and second sets.

Alternatively, the system may include a fire detection system that protects a secured geographic area, a plurality of fire sensors of the fire detection system that detect fires within the secured geographic area, a 2-wire loop having first and second conductors that connect the plurality of fire sensors and a control panel of the fire detection system, the 2-wire loop having first and second ends, each connected to the control panel, a memory that contain a respective resistance value of each of the first and second conductors and a respective resistance value between each of the first and second ends and each of the plurality of sensors and a processor that detects a fault in the 2-wire loop by measuring resistance values from at least one of the opposing ends of the 2-wire loop during a sensor addressing cycle and detects a difference between the measured resistance values and corresponding values in memory that exceeds a predetermined threshold value.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a two-wire loop having first and second conductors that connect a monitoring system with a plurality of addressable sensors and alarm devices of the monitoring system, the two-wire loop having first and second ends connected to the monitoring system;
a memory that contains first respective resistance values of the first and second conductors and second respective resistance values between the first and second ends and between each of the plurality of addressable sensors and alarm devices; and
a processor that detects a fault in the two-wire loop by measuring third resistance values from opposing ones of the first and second ends of the two-wire loop during a scan of the plurality of addressable sensors and alarm devices and compares the third resistance values with corresponding ones of the first and second respective resistance values in the memory.

2. The apparatus as in claim 1 wherein the monitoring system comprises a fire detection system.

3. The apparatus as in claim 1 wherein the processor sequentially measures the first respective resistance values of the first and second conductors and the second respective resistance values between the first and second ends and between each of the plurality of addressable sensors and alarm devices.

4. The apparatus as in claim 3 wherein the processor compares each of the third resistance values with the corresponding ones of the first and second respective resistance values in the memory and generates the fault upon one of the third resistance values exceeding one of the corresponding ones of the first and second respective resistance values by a predetermined amount.

5. The apparatus as in claim 1 wherein processor generates and transmits a message through one of the first and second ends into the two-wire loop, the message having high and low levels defining a destination address and a payload of the message.

6. The apparatus as in claim 5 wherein the processor measures one of the third resistance values of a portion of the two-wire loop during one of the low levels of the message.

7. The apparatus as in claim 5 wherein the destination address comprises a non-existent sensor.

8. The apparatus as in claim 5 wherein the processor sequentially transmits the message addressed to each of the plurality of addressable sensors and alarm devices connected to the two-wire loop.

9. The apparatus as in claim 5 further comprising a current sensor that measures a current through a portion of at least one of the first and second conductors and a voltage across the at least one of the first and second conductors during one of the low levels.

10. The apparatus as in claim 9 wherein the processor divides the voltage by the current to determine one of the third resistance values.

11. An apparatus comprising:
a monitoring system that protects a secured geographic area;
a plurality of addressable sensors and alarm devices of the monitoring system that detects threats within the secured geographic area;
a two-wire loop having first and second conductors that connect the plurality of addressable sensors and alarm devices to the monitoring system, the two-wire loop having a first end connected to the monitoring system and a second end also connected to the monitoring system;
a first set of memory locations that contain a first respective resistance value of each of the first and second conductors;
a second set of the memory locations that contain a second respective resistance value between the first end and each of the plurality of addressable sensors and alarm devices and between the second end and each of the plurality of addressable sensors and alarm devices; and
a processor that detects a fault in the two-wire loop by measuring third resistance values from opposing ones of the first and second ends of the two-wire loop during a scan of the plurality of addressable sensors and alarm devices and compares the third resistance values with corresponding ones of the first and second respective resistance values of the first and second sets.

12. The apparatus as in claim 11 wherein the processor generates and transmits a message through one of the first and second ends into the two-wire loop, the message having a sequence of high and low levels defining one or more of a destination address and a payload of the message.

13. The apparatus as in claim 12 wherein the processor measures one of the third resistance values of a portion of the two-wire loop during one of the low levels of the sequence of high and low levels of the message.

14. The apparatus as in claim 12 wherein the destination address comprises a non-existent sensor.

15. The apparatus as in claim 12 wherein the processor sequentially transmits the message addressed to each of the plurality of addressable sensors and alarm devices connected to the two-wire loop.

16. The apparatus as in claim 12 further comprising a current sensor that measures a current through a portion at least one of the first and second conductors during one of the low levels of the sequence during transmission of the message.

17. The apparatus as in claim 16 further comprising a voltage sensor that measures a voltage across the at least one of the first and second conductors during the one of the low levels of the sequence during the transmission of the message.

18. The apparatus as in claim 17 wherein processor divides the voltage by the current to determine one of the third resistance values.

19. The apparatus as in claim 11 wherein processor measures the third resistance values following activation of the monitoring system and saves the third resistance values into the first and second sets of the memory locations.

20. An apparatus comprising:
a fire detection system that protects a secured geographic area;
a plurality of addressable fire sensors and alarm devices of the fire detection system that detects fires and annunciate the fires within the secured geographic area;
a two-wire loop having first and second conductors that connect the plurality of addressable fire sensors alarm devices and a control panel of the fire detection system, the two-wire loop having first and second ends, each of the first and second ends connected to the control panel;
a memory that contains a first respective resistance value of each of the first and second conductors and a second respective resistance value between each of the first and second ends and each of the plurality of addressable fire sensors and alarm devices; and
a processor that detects a fault in the two-wire loop by measuring third resistance values from at least one of opposing ones of the first and second ends of the two-wire loop during a scan of the plurality of addressable fire sensors and alarm devices and detects a difference between the third resistance values and corresponding ones of the first and second respective resistance values in the memory that exceeds a predetermined threshold value.
